(19) United States
(12) Patent Application Publication
(10) Pub. No.: US 2013/0290009 A1
(43) Pub. Date: Oct. 31, 2013

(54) CLINICAL RESOURCE MANAGEMENT SYSTEM

(71) Applicant: John ROSENBLUM, Calais, VT (US)

(72) Inventor: John ROSENBLUM, Calais, VT (US)

(73) Assignee: ORACLE INTERNATIONAL CORPORATION, Redwood Shores, CA (US)

(21) Appl. No.: 13/603,785

(22) Filed: Sep. 5, 2012

Related U.S. Application Data
(60) Provisional application No. 61/639,136, filed on Apr. 27, 2012.

(51) Int. Cl. G06Q 50/22

(52) U.S. Cl. 705/2

(57) ABSTRACT

Systems, methods, and other embodiments associated with scheduling study groups between clinics when performing clinical studies are described. In one embodiment, a method includes displaying a graphical user interface (GUI) with at least one of a plurality of display screens for scheduling a plurality of groups to clinics. The example method may also include generating, using at least a processor, a provisional schedule of assignments of the plurality of groups to dates for performing the study. The provisional schedule is displayed on the GUI. The provisional schedule displays scheduling conflicts when more than one of the plurality of groups is simultaneously scheduled on a day.

### CROSS REFERENCE TO RELATED APPLICATIONS

This disclosure claims the benefit of U.S. Provisional Patent Application Ser. No. “61/639,136” filed Apr. 27, 2012, titled “A Clinical Resource Management System”, inventor: John Rosenblum, and assigned to the present assignee, and which is incorporated by reference in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Before a new drug or treatment is approved for use it is tested. One way that new drugs and treatments are tested is through a series of clinical trials. Clinical trials may include many periods and forms of testing such as phase I bioavailability (BA) and bioequivalence (BE) studies that provide information to practitioners about the safety and efficacy of a new drug/treatment. To perform these clinical trials, the pharmaceutical industry often uses clinical organizations.

The clinical organizations are corporations that operate clinics, which perform the phase I testing for the new drugs/treatments. The new drugs/treatments are part of studies that vary widely in strategic and financial value. Commonly, a clinical organization needs to schedule an important study into an already busy clinic schedule. To accommodate less important studies that are already scheduled, clinic staff attempt to manually rearrange studies scheduled for different clinic spaces. However, scheduling in this way is time consuming and leads to an inefficient use of clinic space. Because the clinical organizations pay for clinic space regardless of use, inefficient use of the space is costly.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a system associated with scheduling study groups to clinics.

FIG. 2 illustrates one embodiment of a method associated with scheduling study groups to clinics.

FIG. 3 illustrates another embodiment of a method associated with scheduling study groups to clinics.

FIG. 4 illustrates one example of a screenshot of a graphical user interface shown with a clinic schedule screen.

FIG. 5 illustrates one example of a screenshot of a graphical user interface shown with a studies screen.

FIG. 6 illustrates one example of a screenshot of a graphical user interface shown with a new study popup screen.

FIG. 7 illustrates one example of a screenshot of a graphical user interface shown with a study properties screen.

FIG. 8 illustrates one example of a screenshot of a graphical user interface shown with a study group screen.

FIG. 9 illustrates one example of a screenshot of a graphical user interface shown with a new group screen.

FIG. 10 illustrates one example of a screenshot of a graphical user interface shown with a study setup screen.

FIG. 11 illustrates one example of a screenshot of a graphical user interface shown with a new study part screen.

FIG. 12 illustrates one example of a screenshot of a graphical user interface shown with a clinics screen.

FIG. 13 illustrates one example of a screenshot of a graphical user interface shown with an edit clinic screen.

FIG. 14 illustrates one example of a screenshot of a graphical user interface shown with a new clinic screen.

FIG. 15 illustrates an embodiment of a computing system in which example systems and methods, and equivalents, may operate.

### DETAILED DESCRIPTION

Systems, methods and other embodiments are described that are associated with scheduling study groups between clinics when performing clinical studies. In one embodiment, a graphical user interface (GUI) generated by a clinic scheduling system automates scheduling study groups between different clinics. In this way, scheduling many groups between clinics is improved.

Consider that scheduling study groups between many different clinics is a complex task that involves coordinating many different clinics with different study groups on different dates and for different visit durations. For example, each clinical study can include several different study groups with each group having between one and one-hundred and fifty subjects. Each study can also include discontinuous inpatient visits for the subjects. The inpatient visits typically last between one and twenty days in length and can repeat many times. In one embodiment, the GUI can assist in scheduling by automatically scheduling the discontinuous inpatient visits for different groups between different clinics.

In addition to the GUI scheduling discontinuous inpatient visits, the GUI also schedules outpatient visits to the clinics at various points between the inpatient visits. By scheduling study groups between clinics using the GUI scheduling efficiency for the clinics is improved, which represents a major departure from the limited usability of manual spreadsheets.

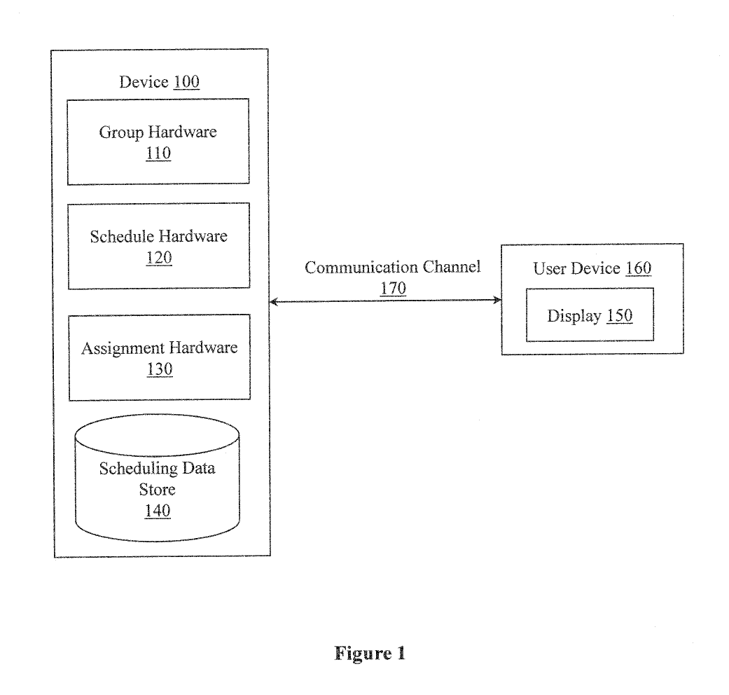

With reference to FIG. 1, one embodiment of a device 100 associated with a clinic scheduling system for scheduling groups of study subjects between different clinics is illustrated. In one embodiment, the device 100 is a computer or other electronic device that includes hardware components for generating a graphical user interface (GUI) and performing different scheduling tasks. For example, the device 100 includes a group hardware 110, a schedule hardware 120, and an assignment hardware 130. The device 100 also includes a scheduling data store 140 that stores information about clinics, groups, and studies that is used for scheduling. The hardware 110, 120, and 130 generate a schedule of clinics which is displayed within the GUI. The GUI is displayed on, for example, a display 150 of a user device 160 over a communication channel 170.

In one embodiment, the group hardware 110 is configured to determine a group schedule for each of a plurality of groups. The plurality of groups are, for example, groups of subjects (e.g., people) that are assigned to participate in a clinical study. Each of the groups can include a plurality of subjects. Additionally, each of the groups can include alternate subjects and active subjects. The alternate subjects are individuals that participate in the study and can substitute for an active subject, if the active subject cannot continue in the clinical study. Often, a small percent of the active subjects will drop out of a study prior to the study beginning. Thus, the alternates can substitute for active subjects that drop out, thereby maintaining a required number of active subjects in the group.

To determine the group schedule, the group hardware 110 retrieves attributes of for each group from the scheduling data store 140. The attributes for a group can be information about a clinical study that the group is participating in, information about the group, and so on. The attributes can be stored in one or more databases that constitute the scheduling data store 140 of the device 100. Alternatively, the scheduling data store 140 can be a remotely located data storage system that is not integrated with the device 100.

In one embodiment, the attributes define information about the clinical study that includes durations for inpatient visits, periods between inpatient visits, times for outpatient visits during the periods between inpatient visits, how many subjects are necessary for a group in the clinical study, a number of periods in the clinical study, and so on. From the attributes, the group hardware 110 is configured to construct a timeline for performing the clinical study with each group. The timeline is a layout of all of the visits (e.g., inpatient visits, outpatient visits) for a group of subjects that outlines relative times (e.g., days) for visits without defining exact dates. The timeline provides a basic overview of relative dates of when a clinic will need to be available for the group.

Consider an example group of subjects assigned to a clinical study. Attributes of the example group can specify that a ten day inpatient visit is required to begin the clinical study. Other attributes about the initial visit can also be specified. For example, the attributes can specify that an initial day is a particular day of the week (e.g., Monday), month (e.g., second December), or a specific date (e.g., May 21, 2013). The attributes can also include times for future visits in relation to the initial visit. For example, the attributes can specify that outpatient visits occur at seven, twelve, thirteen and twenty four days from completion of the initial inpatient visit. Other inpatient visits can also be specified in relation to the initial visit, e.g., 5 day inpatient visit 21 days from completion of the initial visit, and so on.

Accordingly, a timeline for the example group can be generated using the attributes that specify the inpatient and outpatient visits. The timeline illustrates relative dates for all necessary inpatient and outpatient visits relative to an initial visit. The relative dates for each group can also be broken into separate periods for different sections of a study. For example, each different inpatient visit can define a different period for a group. In generally, the timeline is a relative schedule of visits and does not specify actual dates (e.g., month-day-year), but instead specifies days from an initial visit day or dose day. In this way, the timeline for a group can be applied against a calendar with other timelines when generating a provisional schedule. As an alternative, a specific date is indicated for a group, in which case the timeline is generated with actual dates instead of relative dates.

The provisional schedule is generated by the schedule hardware 120. In one embodiment, the schedule hardware 120 is configured to generate the provisional schedule using the timeline for each group. The provisional schedule is a schedule of provisional assignments of the plurality of groups to clinic dates. The provisional schedule can also include provisional assignments of groups to clinics. The term clinic, as used in this disclosure, refers to different spaces in a clinical location or a single space that spans multiple clinical locations. In either case, the clinic is clinical space that can be used for clinical studies. Additionally, use of the term clinic in a plural form, i.e., clinics can refer to multiple clinical spaces in a single location or multiple clinical spaces across multiple locations.

The provisional assignments to clinic dates may be based on a best fit of groups to the clinics (e.g., most efficient use of clinics), as determined by the schedule hardware 120. In one embodiment, the schedule hardware 120 is configured to test different initial dates for the timelines to determine the best fit that has a minimum number of conflicts. A conflict occurs when more than one group is simultaneously scheduled to the same clinic on the same date. Thus, the schedule hardware 120 is configured to produce a provisional schedule that reduces occurrences of conflicts.

In one embodiment, the schedule hardware 120 is configured to use desired starting dates for each group along with the timelines generated by the group hardware 110 to generate the provisional schedule. When using specific dates (e.g., the desired starting dates) to produce the provisional schedule, the schedule hardware 120 may automatically assign groups to clinics to provide a best fit of groups to clinics with a minimum number of conflicts. In this way, the best fit provisional schedule can be displayed to a user that includes a minimum number of conflicts.

In one embodiment, the group hardware 110 displays the provisional schedule within the GUI on the user device 160 to display a visual queue of conflicts between clinics/groups to an administrative user. Using the provisional schedule, the assignment hardware 130 is configured to produce a modified schedule based on an input from, for example, the administrative user. The input is an input received through the GUI that re-assigns one or more of the clinics to a different group because of a conflict. The input may also be an input initially assigning a clinic to each group. That is, instead of the groups being assigned to clinics when the provisional scheduled is generated by the schedule hardware 120, the assignment hardware 130 can assign each group to a clinic based on the input.

In general, the assignment hardware 130 permits resolution of conflicts between clinics that have more than one group assigned for a date. The assignment hardware 130 resolves the conflicts by modifying the provisional schedule to produce a modified schedule that reflects the input specifying a change for a start date of a group or a change to a clinic assignment for a group.

By changing start dates for groups and/or clinic assignments, different “what if” scenarios can be easily visualized with the modified schedules. Additionally, different benefits of each “what if” scenario (i.e., each modified schedule) can then be considered and a modified schedule that best balances different considerations can be selected for use.

As an example, consider that two different groups with identical timelines are scheduled to start on the same date in the provisional schedule. The timelines for the groups define periodic inpatient visits that alternate one week of inpatient visits followed by one week with no visits. Thus, if the groups are scheduled to begin on the same start date they will completely conflict if also scheduled to the same clinic.

However, the assignment hardware 130 can resolve the conflict based on an input received through the GUI that specifies modifying a start date of one of the groups by a week. This change resolves the conflicts since the groups are then staggered by a week freeing the clinic to accommodate both groups at separate times. Alternatively, a user can provide an input to the assignment hardware 130 that assigns each group to a different clinic, which also solves the conflict and doesn't require changing start dates. While the current example discusses only two groups, the assignment hardware 130 is configured to modify a provisional schedule that includes a plurality of groups in order to resolve conflicts and to visualize many different “what if” scheduling scenarios on the GUI. In this way, clinic space can be more efficiently scheduled by visualizing different “what if” schedules on the GUI.

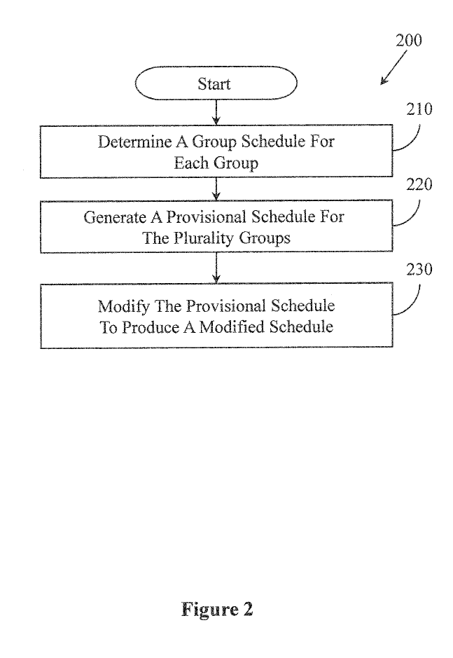

Further details of scheduling study groups between different clinics for performing a clinical study are discussed with reference to FIG. 2. FIG. 2 illustrates one embodiment of a computer-implemented method 200 associated with scheduling groups between different clinics using a graphical user interface (GUI). FIG. 2 will be discussed from the perspective of the device 100 of FIG. 1.

At 210, the device 100 of FIG. 1 determines a group schedule for each of a plurality of groups. In one embodiment, the group schedule for each group is a timeline of inpatient and outpatient visits for a clinical study. The device 100 determines the group schedules from attributes of the study and each group (e.g., duration and number of inpatient visits, frequency of outpatient visits, a number of subjects, a number of alternates, and so on). The attributes of the study and for each group are retrieved by the device 100 from a local storage (e.g., scheduling data store 140) and then analyzed to produce the timelines. The attributes can be predetermined based on a study protocol and/or are specifically defined by data received through the GUI.

Each group schedule (e.g., timeline) generated at 210, defines relative times for assigning the group to a clinic for inpatient visits and outpatient visits. At 220, the device 100 uses the group schedules from 210 to generate the provisional schedule for the plurality of groups. The provisional schedule includes assignments of each group to dates for inpatient and outpatient visits. The provisional schedule may also include assignments to clinics for each group. As part of generating the provisional schedule at 220, the device 100 may consider many different factors to make provisional assignments of groups to dates and/or clinics. For example, when assigning a group to a clinic, the device 100 may consider a capacity for the clinic, equipment needed for the group and equipment available at the clinic, and so on.

In one embodiment, the device 100 generates the provisional schedule by charting days when each group is scheduled for clinic visits (e.g., inpatient or outpatient) on a graphic display of the GUI. Charting days for clinic visits can include indicating days for each group on, for example, a Gantt chart or other display. The display can include a graphic (e.g., a bar) for each visit for a group against a timeline of days. Each bar can indicate a number of patients in the group, a clinic to which the group is assigned, a type of visit (e.g., inpatient or outpatient), and so on.

The display illustrates conflicts between groups for the provisional schedule as bars that are in the same column and are assigned to the same clinic. Accordingly, the display of the GUI assists with determining possible scheduling conflicts when more than one of the plurality of groups is simultaneously scheduled to the same day and/or clinic.

At 230, the device 100 modifies the provisional schedule to produce a modified schedule that is then displayed on the GUI by the device 100. In one embodiment, the provisional schedule is modified based, at least in part, on an input from the GUI. For example, the input can be from a user of the GUI. The input can be an input to the GUI that assigns a clinic to one or more of the groups, re-assigns one or more clinics that have a conflict, changes a start date for one or more groups, and so on.

In this way, each time that an input is received through the GUI to modify the provisional schedule, a modified schedule is produced. Consequently, many different modified schedules can be produced that illustrate different “what if” circumstances for scheduling groups between clinics. The “what if” schedules are contingency schedules that account for different circumstances (e.g., date changes, clinic changes, etc.). From the modified schedules, the device 100 can select a best fit or most efficient schedule to implement. Selecting a most efficient schedule can be based on a user input or simply changing the provisional schedule until no further conflicts exist. In this way, the GUI improves scheduling of the plurality of groups between clinics.

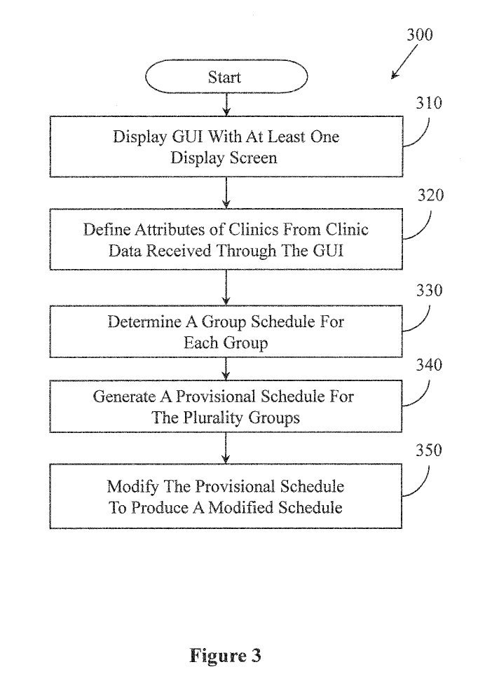

Further aspects of the GUI and scheduling study groups between clinics are discussed with respect to FIG. 3. FIG. 3 illustrates a computer-implemented method 300 associated with scheduling study groups between different clinics. FIG. 3 will be discussed from the perspective of the device 100 of FIG. 1. Method 300 includes several elements similar to elements of method 200. For example, elements 330, 340, and 350 are similar to elements 210, 220, and 230 of method 200, respectively. However, method 300 also includes elements 310 and 320.

At 310, the device 100 displays the GUI with at least one of a plurality of display screens. The display screens are different screens generated by the device 100 that are for scheduling the plurality of groups to clinics. The display screens can include screens for entering information about clinics, groups, studies, and so on. The display screens can also include screens for displaying the group schedules, timelines, and the provisional schedules. In one embodiment, the device 100 is a web server that provides the GUI as part of a webpage. Accordingly, a user can interact with the GUI over a network or other communication channel (e.g., communication channel 170, the Internet, etc.) using a remote device (e.g., user device 160). Through interactions of the user with the GUI, the device 100 can receive various inputs, for example, at 320, that modify the provisional schedule.

Additionally, different data can be received through the display screens of the GUI for various purposes. For example, at 320, the device 100 defines attributes of the clinics from clinic data received through the GUI. To define the clinics, an input of various attributes of the clinics is received via the GUI. The data can be entered into a display screen of the GUI by a user and then provided through the GUI to the device 100. The device 100 uses the data to define the clinics so that the clinics can be used to schedule groups. For example, defining the clinics can include defining for each clinic a number of beds, a capacity for inpatient visits, a capacity for outpatient visits, available equipment (e.g., EKG machine, MRI machines, ultrasounds machines, etc.), staff available at each clinic (e.g., phlebotomist, cardiologist, nurses, etc.), and so on.

At 330 of method 300, similar to 210 of method 200, a group schedule (e.g., timeline of visits) is determined for each group. In one embodiment, at 330, data is received by the device 100 through the GUI that defines each group schedule. In other embodiments, at 330, the device 100 may determine the group schedules from information received through the GUI and from attributes of a clinical study and other information stored in the scheduling data store 140.

At 340, similar to 220 of method 200, a provisional schedule is generated for the plurality of groups. In one embodiment, the provisional schedule includes each of the group schedules combined into one master timeline with assignments of dates to each group schedule. Thus, the provisional schedule displays conflicts between groups since each group schedule is combined into the master timeline. The master timeline may be in the form of a Gantt chart or other visual graph that easily indicates conflicts.

At 350, similar to 230 of method 200, inputs are received by the device 100 that modify the provisional schedule to resolve conflicts. The inputs are reflected in the master timeline so that a user can visualize changes to the provisional schedule.

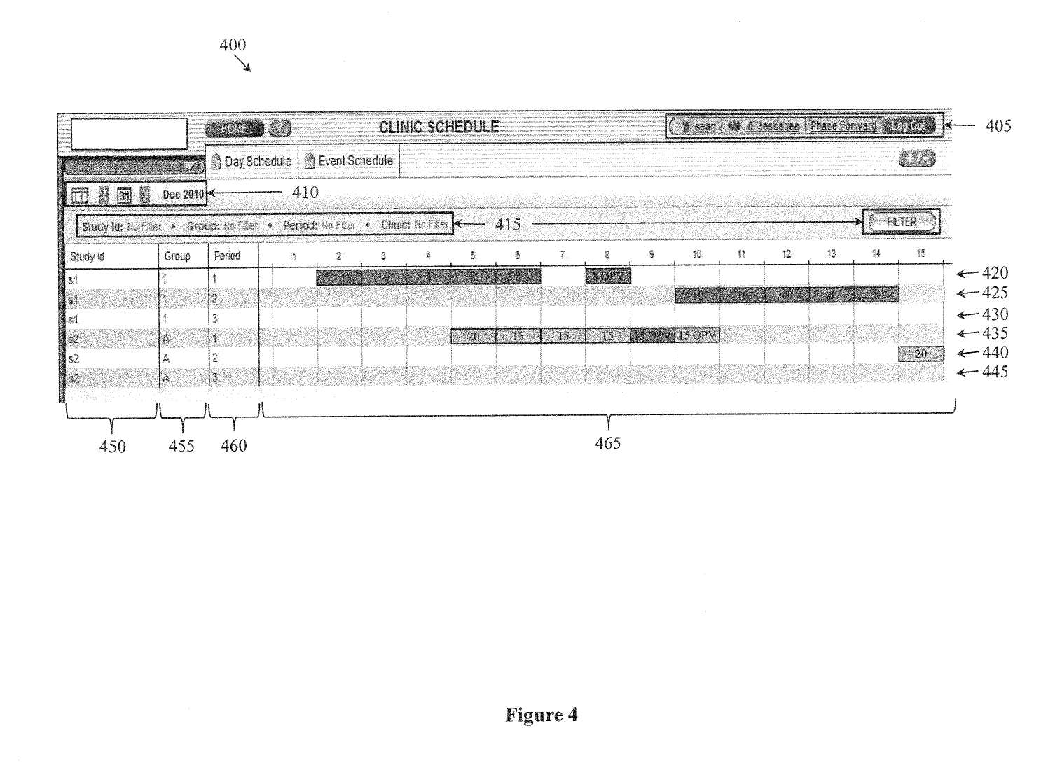

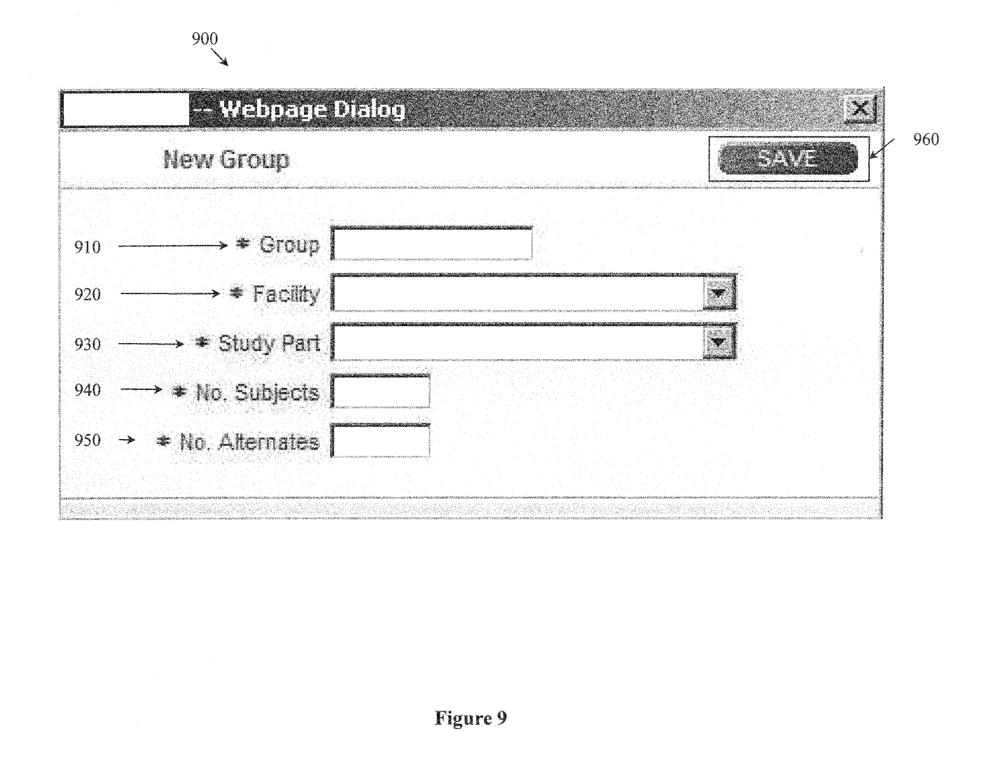

FIGS. 4-16 illustrate various examples of display screens of the GUI produced by the device 100. For example, FIG. 4 illustrates one example of a screenshot of a graphical user interface (GUI) shown with a clinic schedule screen 400. The clinic schedule screen 400 includes user information 405. The user information 405 is information about a user that is logged into the GUI. Because different functions available to users are based on, for example, different job roles and security clearances, a user can be required to log into the GUI before being permitted to provide any inputs that may modify the provisional schedule or attributes of groups, studies, and so on.

The clinic schedule screen 400 also includes a date selection option 410 that permits selection of different timeframes (e.g., different months). In FIG. 4, the clinic schedule screen 400 is displaying a schedule for Dec. 1-15, 2010, as reflected by the date selection option 410. A filter option 415 is configured to permit filtering of which studies, groups, periods, and clinics are displayed in rows 420-445. Each of the rows 420, 425, 430, 435, 440, and 445 include information about a period of a study for a group. For example, row 420 shows group 1 that is part of study s1 for period 1. While the clinic schedule screen 400 displays each period for a group in a separate row, in one embodiment, each period for a group can be displayed in a single row with periods being denoted by different colors or a vertical marker indicating a boundary for each different period.

The rows 420-445 can be sorted in ascending or descending order according to values of a column selected for sorting. By receiving an input from, for example, a mouse click on a column header, rows are sorted according to values of the column. The clinic schedule screen 400 also includes a study id column 450, a group column 455, a period column 460, and a timeline column 465. The study id column 450 includes an identifier of a study being performed on a group in a corresponding row (e.g., s1). The group column 455 identifies with which group a row corresponds. The period column 460 identifies which period of a study is being performed on a group in a corresponding row.

The timeline column 465 displays each day of a month as a column. The timeline column 465 also displays timelines for a group. As discussed previously, a timeline for a group is a layout of all of the visits (e.g., inpatient visits, outpatient visits) for a group of subjects that outlines relative times (e.g., days) for the visits. In FIG. 4, there are two timelines that are each separated into periods. A first timeline for group 1 includes rows 420, 425, and 430. A second timeline for group A includes rows 435, 440, and 445. The first and second timelines are in the form of a Gantt chart. Bars labeled with numbers in the first and second timeline indicate clinic visit days. The numbers indicate a number of subjects for the group on that day. “OPV” indicates an outpatient visit while other bars with only numbers are inpatient visits/stays.

Conflicts are shown by overlapping columns. For example, group 1 and group A have overlaps in days 5, 6, 8, and 10. Thus, the clinic schedule screen 400 indicates to a user that group 1 and group A cannot be scheduled at the same clinic on days 5, 6, 8, and 10.

In general, once an inpatient visit of two or more consecutive days begins, patients are not transferred between clinics to accommodate another group. For example, on day 5 group 1 is in day 4 of a 5 day inpatient visit. Group A is scheduled to begin a 4 day inpatient visit on day 5. However, a clinic assignment for group 1 will not be changed as of day 5 because transferring a group of subjects is not permitted. Thus, group A must be assigned to a different clinic for day 5 or starting dates for either group 1 or group A must be modified to accommodate the conflict.

However, as illustrated in FIG. 4, groups are shown already scheduled to clinics. The different clinics are denoted by differently colored bars for each group. Group 1 is scheduled to a first clinic as shown by dark bars and Group A is scheduled to a second clinic as shown by lighter bars, except on day 9 when group A is scheduled to the first clinic for an outpatient visit. Depending on a configuration of the GUI, the schedule illustrated in FIG. 4 can be a provisional schedule with automatic assignments of groups to clinics, or a modified schedule that has been modified according to inputs received through the GUI to resolve conflicts. In either case, as illustrated, there are no conflicts between Group A and Group 1 because on days with potential conflicts the groups are scheduled to different clinics.

Additionally, in this example of the clinic schedule screen 400, instead of resolving the conflicts by implementing different clinic assignments as shown, the conflicts could potentially be resolved by changing start dates for the groups. For example, in FIG. 4, a start date for group 1 is Dec. 2, 2010, and a start date for group A is Dec. 5, 2010. Modifying the start date of group A to Dec. 15, 2010 would also resolve the conflicts on days 5, 6, 8, and 10. Period 3 for each group is not shown in FIG. 4 because the clinic schedule screen 400 is scrolled to the left leaving a remainder of December out-of-view. However, scrolling to the right in screen 400 will display day 16 and beyond of December and, thus, also period 3 for each study. While it appears from the clinic scheduling screen 400 that moving the start date for group 2 to day 15 would resolve the conflicts, this is of course without consideration to period 3.

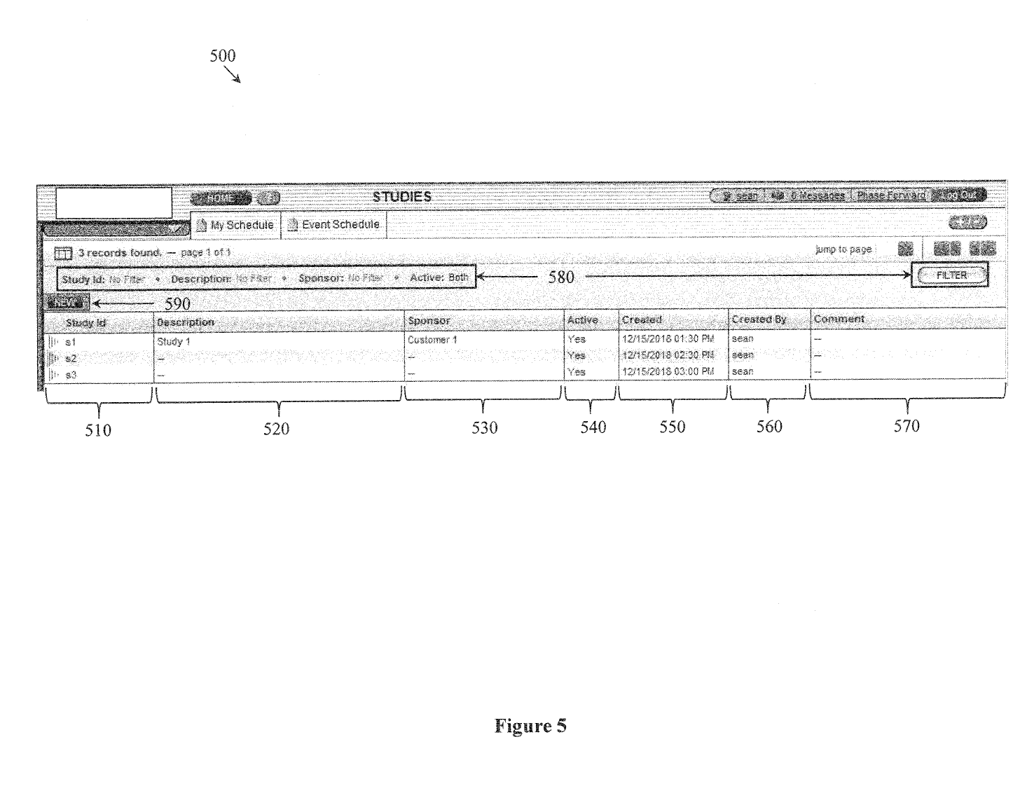

Continuing to FIG. 5, one example of a screenshot of the GUI with a studies screen 500 is shown. The studies screen 500 permits a user to define studies and attributes of the studies. The studies screen 500 includes a study id column 510, a description column 520, a sponsor column 530, an active column 540, a created column 550, a created by column 560, and a comment column 570. The study id column 510 lists an identifier for a study in a corresponding row. The description column 520 provides a brief description of each study. The sponsor column 530 identifies a sponsor of the study (e.g., a pharmaceutical company) that is paying to have the study performed. The active column 540 indicates whether a study is currently active (e.g., in progress) or inactive (e.g., completed). Similar to the clinic schedule screen 400 of FIG. 4, each row can be sorted via values of a desired column, and filter options 580 can be used to filter which studies are displayed in the rows. A new button 590 can be selected to add a new study.

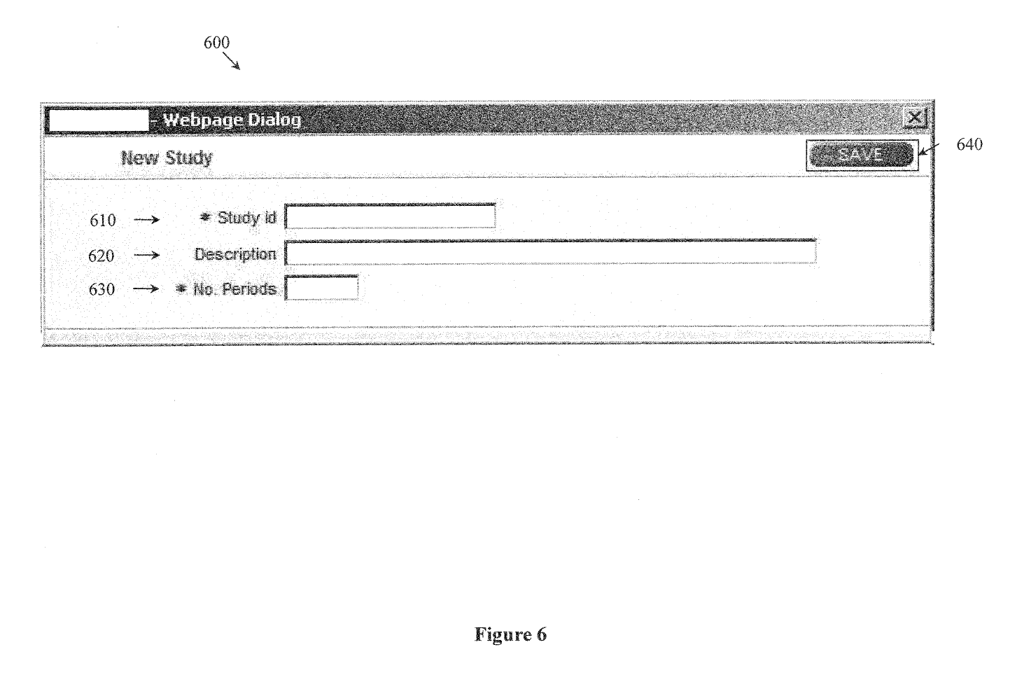

Upon selecting the new button 590 a new study screen 600 is displayed, as illustrated in FIG. 6. The new study screen 600 permits adding of new studies for assignment to groups. Attributes shown in the new study screen 600 include a study name 610, a study description 620, and a number of periods 630. Selecting save button 640 saves the attributes of a new clinic in the device 100 of FIG. 1 that can then be used when assigning studies to groups. While screen 600 illustrates attributes for studies, the attributes can include other information, such as a number of days for inpatient visits, a number of outpatient visits, relative time periods between the inpatient visits and outpatients visits, time periods between outpatient visits, and so on.

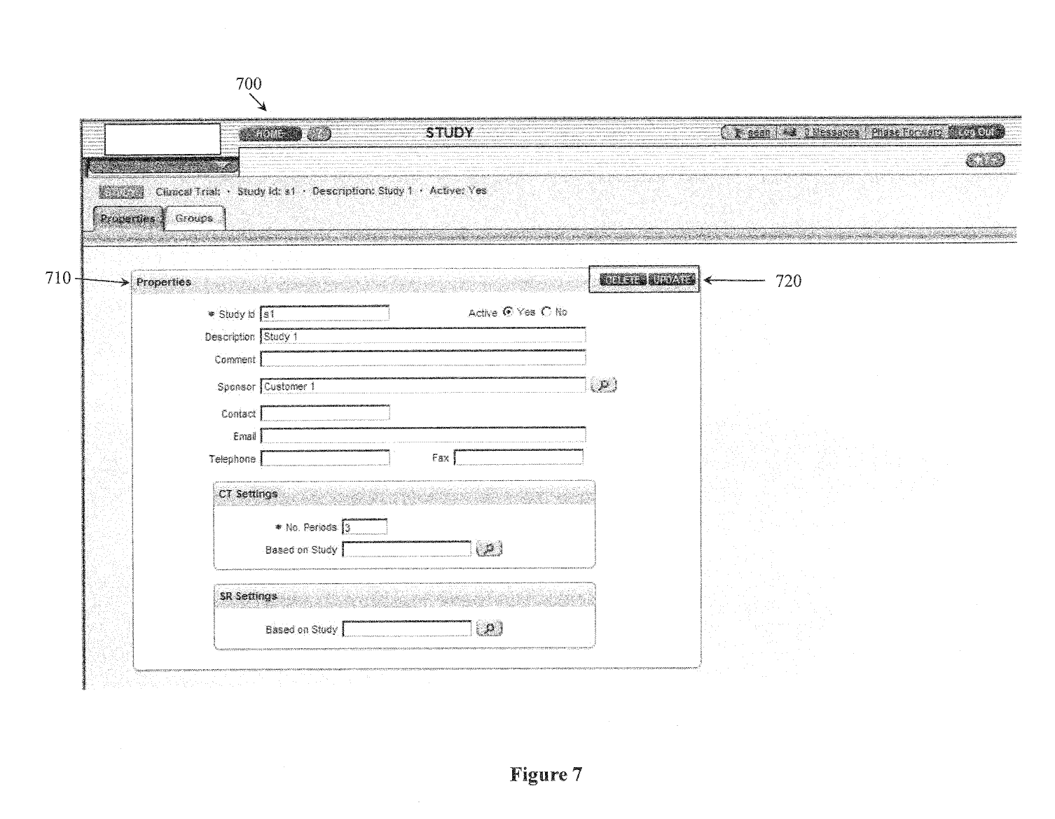

In one embodiment, upon selecting save on the new study screen 600 a study properties screen 700 of the GUI is displayed, as shown in FIG. 7. In one embodiment, the study properties screen 700 is automatically populated with the information from new study screen 600. Information displayed on the study properties screen 700 is populated from, for example, a database (e.g., scheduling data store 140) in the device 100 of FIG. 1. The study properties screen 700 includes a properties box 710 with a plurality of fields for defining different attributes of a study. The study properties screen 700 can also be used to update attributes of existing studies or delete existing studies, as illustrated by controls 720.

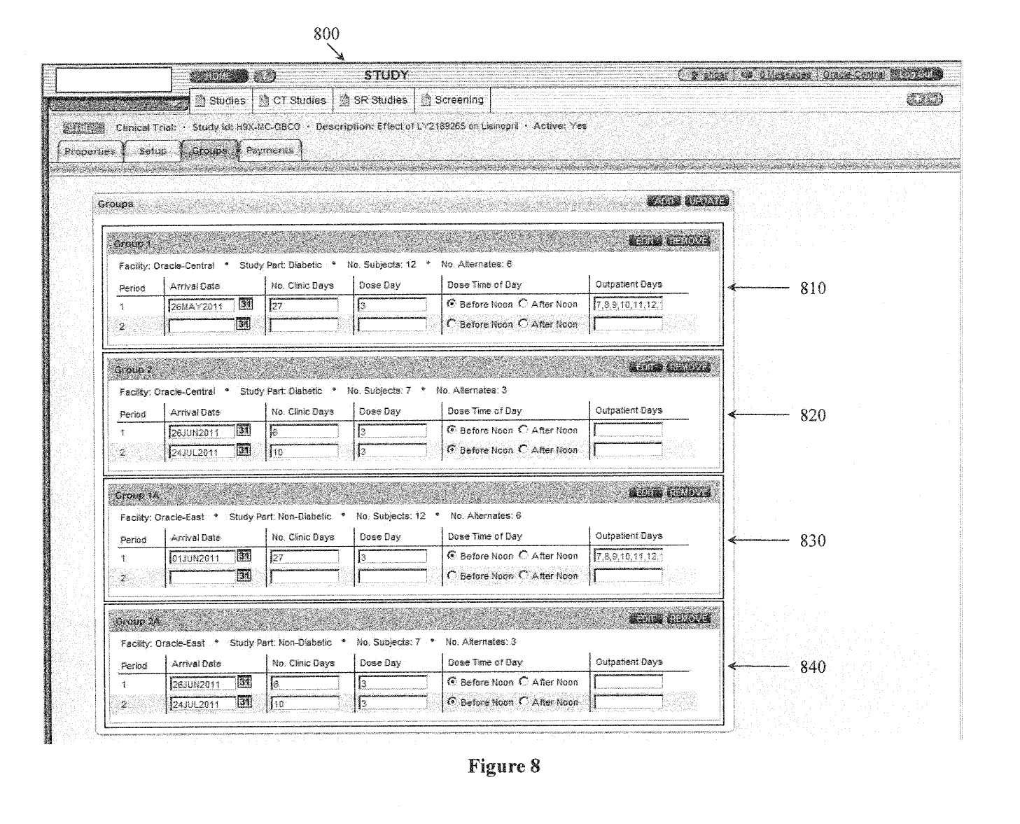

Continuing to FIG. 8, an example screenshot of a study groups screen 800 of the GUI is shown. The study groups screen 800 permits defining attributes for groups on which studies can be performed. In one embodiment, the study groups screen 800 is configured to permit users to enter a timeline for a group that defines clinical residence periods for inpatient and outpatient visits. For example, the study groups screen 800 shows four separate groups 810, 820, 830, and 840. Each of the groups 810, 820, 830, and 840 displays one row for each period in the study. Each row includes, for example, a period number, arrival date, number of clinic days (e.g., inpatient days), a dose day, a dose time of day (radio button with options “Before Noon” and “After Noon”), and outpatient days. Some of the fields (e.g., arrival date) of a row can be optional and/or are modifiable in other screens such as the clinic schedule screen 400 of FIG. 4. Each group also has general information that includes a number of subjects and a number of alternates. In one embodiment, each group also includes a facility assignment (e.g., “Oracle-Central”), and a study part.

New groups can be added and/or updated from the study groups screen 800. For example, selecting “ADD” initiates a popup new group screen 900. The new group screen 900 includes attributes of a group. The attributes include a group 910, which is an identifier/name for a group. The attributes also include a facility 920 assigns the group to a particular facility (e.g., hospital) that includes one or more clinics. Alternatively, the facility 920 can be a clinic assignment for the group. The attributes include a study part 930, which specifies in which part of a study the group is participating. The attributes include a number of subjects 940 and a number of alternates 950. When save button 960 is initiated, the GUI is configured to save information in the fields 910-950 to, for example, the device 100 of FIG. 1.

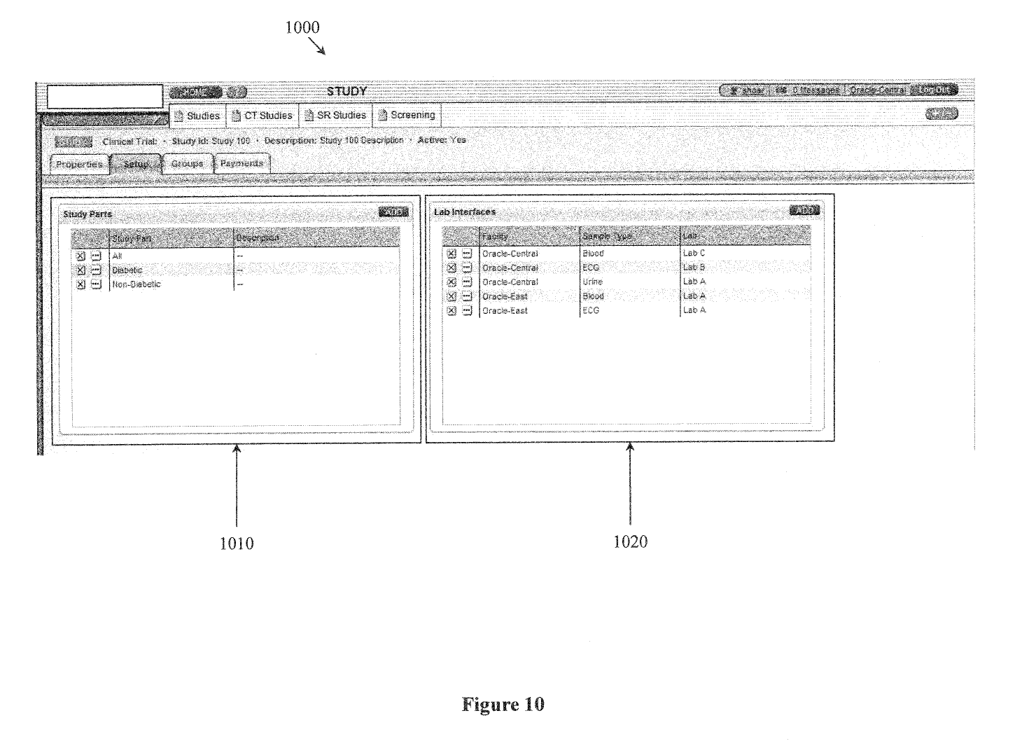

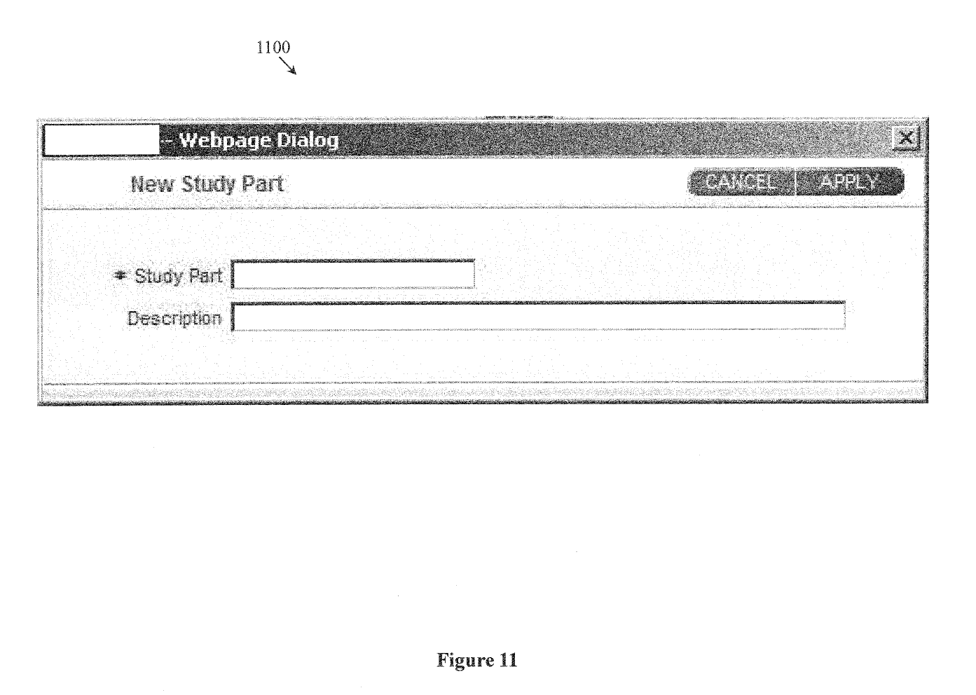

FIG. 10 illustrates a study setup screen 1000. The study setup screen includes lists of study parts 1010 and lists of lab interfaces 1020. The lists 1010 and 1020 display information for defining studies and permit adding and modifying information for defining studies. FIG. 11 illustrates a screen for a new study part 1100 that provides fields for defining/modifying attributes of each element.

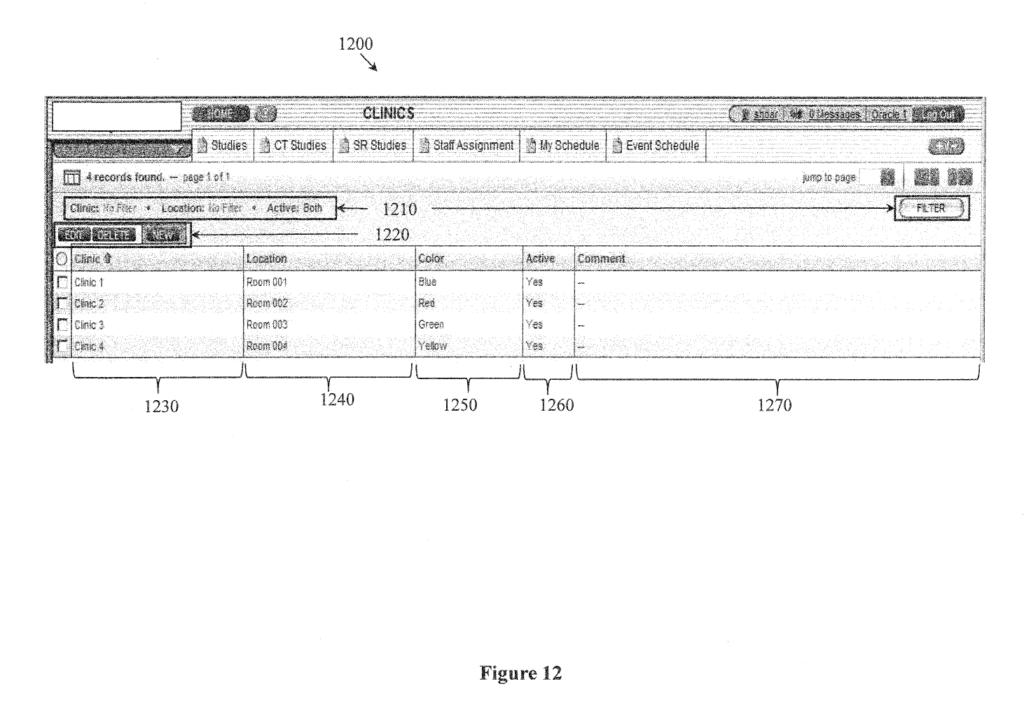

FIG. 12 illustrates an example screenshot of a clinic screen 1200. The clinic screen 1200 permits editing, deleting, and adding clinics that are used to generate schedules. The clinic screen 1200 includes controls such as filter options 1210 and modify buttons 1220. The clinics are displayed on the clinic screen 1200 in a column and row format with the columns including a clinic name 1230, a location 1240, a color 1250, an active status 1260, and a comment column 1270. The color 1250 defines a color for a clinic when displaying an assignment of a group to a clinic on the clinic schedule screen 400 of FIG. 4. To delete a clinic, a corresponding checkbox in a row of the clinic is first selected. After the checkbox has been selected, selecting the delete button of the controls 1220 performs the operation for the selected clinic(s).

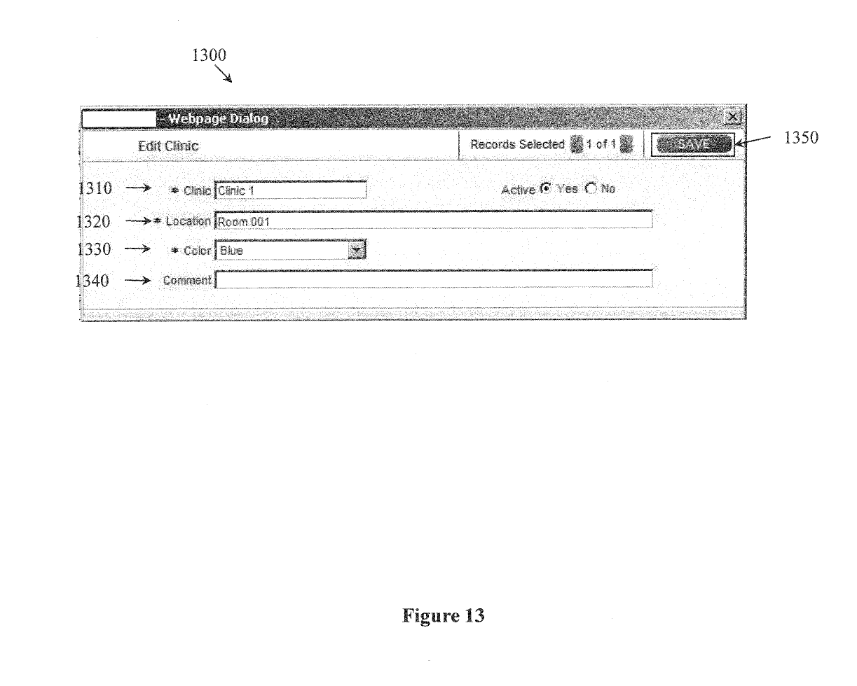

In a similar fashion, selecting the new button from the controls 1220 initiates an edit clinic screen 1300 of the GUI, as shown in FIG. 13. The edit clinic screen 1300 permits editing of clinics currently available on the clinics screen 1200. Attributes shown in edit screen 1300 include a clinic name 1310, a clinic location 1320, a color 1330 for displaying the clinic on the clinic schedule screen 400 of FIG. 4, and a comment field 1340. Selecting save button 150 saves edits in the device 100 of FIG. 1.

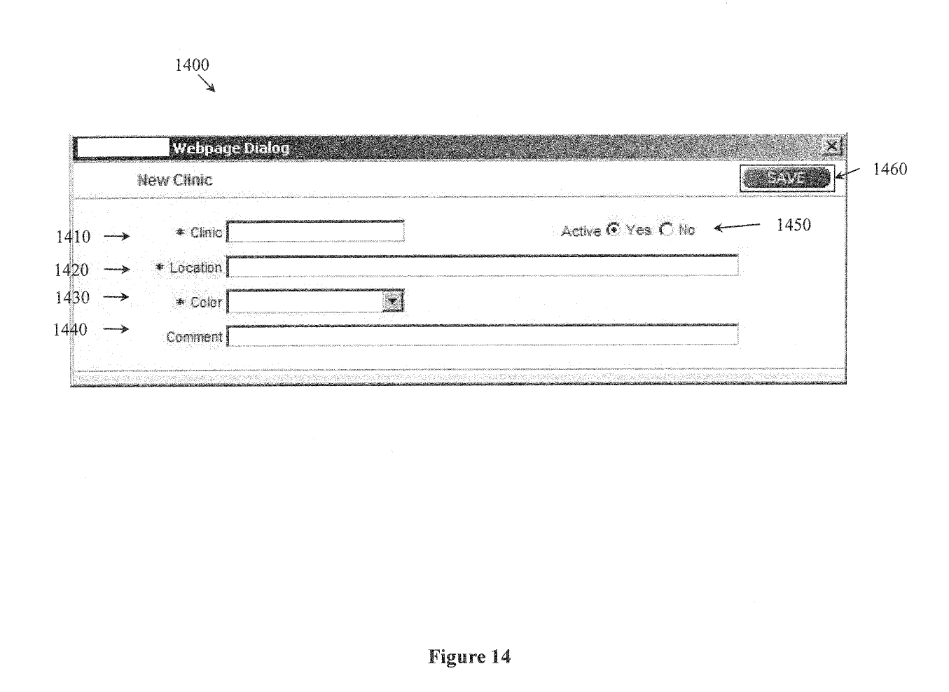

Selecting the new button from the controls 1220 of FIG. 12 initiates a new clinic screen 1400 of the GUI, as shown in FIG. 14. The new clinic screen 1400 permits adding of new clinics that will then appear on the clinics screen 1200. Attributes shown in the new clinic screen 1400 include a clinic name 1410, a clinic location 1420, a color 1430 for displaying the clinic on the clinic schedule screen 400 of FIG. 4, a comment field 1440, and an active radio button option 1450. Selecting save button 1460 saves a new clinic in the device 100 of FIG. 1 that can then be used when scheduling groups. While screens 1200-1400 illustrate a limited set of attributes for clinics, the attributes for clinics can include other information, such as available machines, a number of rooms, beds per room, and so on.

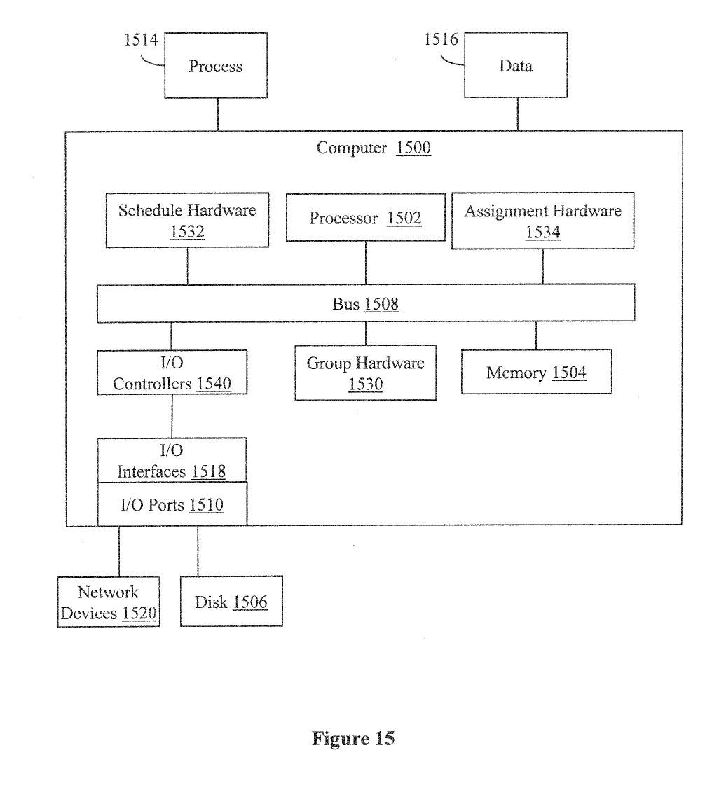

FIG. 15 illustrates an example computing device in which example systems and methods described herein, and equivalents, may operate. The example computing device may be a computer 1500 that includes a processor 1502, a memory 1504, and input/output ports 1510 operably connected by a bus 1508. In one example, the computer 1500 may include a group hardware 1530 configured to determine a group schedule for each of a plurality of groups. The computer 1500 may also include a schedule hardware 1532 configured to generate a provisional schedule of assignments of the plurality of groups to clinics. The computer 1500 may also include an assignment hardware 1534 configured to modify the provisional schedule to produce a modified schedule. In different examples, the hardware 1530, 1532, and 1534 may be implemented in various hardware components, a non-transitory computer-readable medium with stored instructions, firmware, and/or combinations thereof. While the hardware 1530, 1532, and 1534 elements are illustrated as hardware components attached to the bus 1508, it is to be appreciated that in one example, the elements 1530, 1532, and 1534 could be implemented in the processor 1502.

Generally describing an example configuration of the computer 1500, the processor 1502 may be a variety of various processors including dual microprocessor and other multi-processor architectures. A memory 1504 may include volatile memory and/or non-volatile memory. Non-volatile memory may include, for example, ROM, PROM, and so on. Volatile memory may include, for example, RAM, SRAM, DRAM, and so on.

A disk 1506 may be operably connected to the computer 1500 via, for example, an input/output interface (e.g., card, device) 1518 and an input/output port 1510. The disk 1506 may be, for example, a magnetic disk drive, a solid state disk drive, a floppy disk drive, a tape drive, a Zip drive, a flash memory card, a memory stick, and so on. Furthermore, the disk 1506 may be a CD-ROM drive, a CD-R drive, a CD-RW drive, a DVD ROM, and so on. The memory 1504 can store a process 1514 and/or a data 1516, for example. The disk 1506 and/or the memory 1504 can store an operating system that controls and allocates resources of the computer 1500.

The bus 1508 may be a single internal bus interconnect architecture and/or other bus or mesh architectures. While a single bus is illustrated, it is to be appreciated that the computer 1500 may communicate with various devices, logics, and peripherals using other busses (e.g., PCIE, 1394, USB, Ethernet). The bus 1508 can be types including, for example, a memory bus, a memory controller, a peripheral bus, an external bus, a crossbar switch, and/or a local bus.

The computer 1500 may interact with input/output devices via the i/o interfaces 1518 and the input/output ports 1510. Input/output devices may be, for example, a keyboard, a microphone, a pointing and selection device, cameras, video cards, displays, the disk 1506, the network devices 1520, and so on. The input/output ports 1510 may include, for example, serial ports, parallel ports, and USB ports.

The computer 1500 can operate in a network environment and thus may be connected to the network devices 1520 via the i/o interfaces 1518, and/or the i/o ports 1510. Through the network devices 1520, the computer 1500 may interact with a network. Through the network, the computer 1500 may be logically connected to remote computers. Networks with which the computer 1500 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data on a non-transitory computer readable medium. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, a non-transitory computer readable medium that stores instructions, and/or combinations of each to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A non-transitory computer-readable medium storing computer-executable instructions that when executed by a computer, which includes a processor, cause the computer to perform a method, the method comprising:
determining, using at least the processor, a group schedule for each of a plurality of groups, wherein each of the plurality of groups includes a plurality of subjects assigned to a clinical study, and wherein the group schedule for each group is a timeline for performing the clinical study on the plurality of subjects;
generating, using at least the processor, a provisional schedule of assignments of the plurality of groups to clinics, wherein the clinics perform phase I clinical studies, wherein the provisional schedule displays scheduling conflicts when more than one of the plurality of groups is simultaneously scheduled to one of the clinics; and
modifying, using at least the processor, the provisional schedule to produce a modified schedule, wherein modifying the provisional schedule is based, at least in part, on an input from a graphical user interface (GUI) that re-assigns one or more clinics that have a conflict.

2. The non-transitory computer-readable medium of claim 1, wherein the input assigns one of the clinics to each group, and wherein modifying the provisional schedule includes modifying a start date for one of the plurality of groups based, at least in part, on the input.

3. The non-transitory computer-readable medium of claim 1, further comprising:
displaying the GUI with at least one of a plurality of display screens for scheduling the plurality of groups to clinics; and
defining attributes of the clinics from clinic data received through the GUI, wherein the clinics are medical clinics for performing phase I clinical studies.

4. The non-transitory computer-readable medium of claim 1, wherein the provisional schedule is a Gantt chart displayed on the GUI, and wherein the Gantt chart includes assignments of each of the plurality of groups to days for performing the clinical study.

5. The non-transitory computer-readable medium of claim 1, wherein the timeline includes assigned days for inpatient and outpatient visits to a clinic for each of the plurality of groups.

6. The non-transitory computer-readable medium of claim 1, wherein the provisional schedule includes provisional assignments of the plurality of groups to the clinics, and wherein the provisional assignments are based, at least in part, on the timeline for each of the plurality of groups.

7. The non-transitory computer-readable medium of claim 1, wherein modifying the provisional schedule includes modifying the provisional schedule by re-assigning clinics between groups of the plurality of groups and adjusting dates for one or more of the plurality of groups, and wherein the modified schedule is a contingency schedule.

8. The non-transitory computer-readable medium of claim 1, wherein determining the group schedule for each of the plurality of groups includes receiving attributes for each of the plurality of groups, wherein the attributes for each group include a number of subjects, a number of alternates, and the timeline that defines relative times for inpatient visits and outpatient visits from a start date.

9. A system for scheduling a plurality of groups between clinics that perform phase I clinical studies, the system comprising:
group hardware configured to determine a group schedule for each of the plurality of groups, wherein each of the plurality of groups includes a plurality of subjects assigned to a clinical study, and wherein the group schedule for each group is a timeline for performing the clinical study on the plurality of subjects;
schedule hardware configured to generate a provisional schedule of assignments of the plurality of groups to clinics, wherein the provisional schedule displays scheduling conflicts when more than one of the plurality of groups is simultaneously scheduled to one of the clinics; and
assignment hardware configured to modify the provisional schedule to produce a modified schedule, wherein modifying the provisional schedule is based, at least in part, on an input that re-assigns one or more clinics that have a conflict.

10. The system of claim 9, wherein the input assigns one of the clinics for each group, and wherein modifying the provisional schedule includes modifying a start date for one of the plurality of groups based, at least in part, on the input.

11. The system of claim 9, wherein the group hardware is configured to:
display the GUI with at least one of a plurality of display screens for scheduling the plurality of groups to clinics, and
define attributes of the clinics from clinic data received through the GUI, wherein the clinics are medical clinics for performing phase I clinical studies.

12. The system of claim 9, wherein the group hardware is configured to display the provisional schedule as a Gantt chart on the GUI, and wherein the Gantt chart includes assignments of each of the plurality of groups to dates for performing the clinical study.

13. The system of claim 9, wherein the timeline includes assigned days for inpatient and outpatient visits to a clinic for each of the plurality of groups.

14. The system of claim 9, wherein the provisional schedule includes provisional assignments of the plurality of groups to the clinics, and wherein the assignments are based, at least in part, on the timeline for each of the plurality of groups.

15. The system of claim 9, wherein the assignment hardware is configured to modify the provisional schedule by re-assigning clinics between groups of the plurality of groups and adjusting dates for one or more of the plurality of groups, and wherein the modified schedule is a contingency schedule.

16. The system of claim 9, wherein the group hardware is configured to determine the group schedule for each of the plurality of groups by receiving attributes for each of the plurality of groups through the GUI, and wherein the attributes for each group include a number of subjects, a number of alternates, and the timeline that defines relative times for assigning the group to a clinic for inpatient visits and outpatient visits from an initial date.

17. A method for scheduling a plurality of groups between clinics that perform phase I clinical studies, wherein each of the plurality of groups includes a plurality of subjects assigned to a study, the method comprising:
displaying a graphical user interface (GUI) with at least one of a plurality of display screens for scheduling the plurality of groups to clinics; and
generating, using at least a processor, a provisional schedule of assignments of the plurality of groups to dates for performing the study, wherein the provisional schedule is displayed on the GUI, and wherein the provisional schedule displays scheduling conflicts when more than one of the plurality of groups is simultaneously scheduled on a day.

18. The method of claim 17, further comprising:
determining a group schedule for each of the plurality of groups, wherein the group schedule for each group is a timeline for performing the study on the plurality of subjects, and wherein generating the provisional schedule includes combining the group schedule for each of the plurality of groups into a master timeline.

19. The method of claim 17, further comprising:
defining attributes of the clinics from clinic data received through the GUI, wherein the clinics are medical clinics for performing phase I clinical studies.

20. The method of claim 17, further comprising:
modifying the provisional schedule to produce a modified schedule, wherein modifying the provisional schedule is based, at least in part, on an input from the GUI that re-assigns one or more clinics that have a conflict.
